(19) United States
(12) Patent Application Publication
(10) Pub. No.: US 2014/0122014 A1
(43) Pub. Date: May 1, 2014

(54) METHOD AND DEVICE FOR DETECTING AT LEAST ONE UNEVENNESS OF THE ROAD SURFACE

(71) Applicant: Robert Bosch GmbH, Stuttgart (DE)

(72) Inventors: Gottfried Flik, Leonberg (DE); Sven Zinober, Friolzheim (DE); Juergen Wendt, Stuttgart (DE); Fabian Henrici, Stuttgart (DE)

(73) Assignee: Robert Bosch GmbH, Stuttgart (DE)

(21) Appl. No.: 14/063,081

(22) Filed: Oct. 25, 2013

(30) Foreign Application Priority Data
Oct. 26, 2012 (DE) 10 2012 219 631.5

(51) Int. Cl. G01B 21/30

(52) U.S. Cl. CPC G01B 21/30
USPC 702/141; 702/167

(57) ABSTRACT

A method for detecting at least one unevenness of the road surface includes reading in a plurality of records that each have at least one geographic position and one information item allocated to this geographic position about a detected local unevenness of the road surface. The method further includes detecting the unevenness of the road surface when information, allocated to an identical geographic position, from a number of records represents in each case a locally detected unevenness of the road surface.

This application claims priority under 35 U.S.C. §119 to patent application no. DE 10 2012 219 631.5, filed on Oct. 26, 2012 in Germany, the disclosure of which is incorporated herein by reference in its entirety.

### BACKGROUND

The present disclosure relates to a method for detecting at least one unevenness of the road surface, to a method for providing an information item about an unevenness of the road surface in the environment of a road user, to corresponding devices and to a corresponding computer program product.

In modern vehicles, the driving comfort of the vehicle passengers becomes ever more important, especially the soft driving performance of the vehicle is increasingly gaining significance and faulty triggering of safety means of the vehicle having to be avoided at the same time. Conventionally, linking vehicles to the Internet is already on offer, for example in order to convey service-related data to the OEMs. Smartphones and the applications running on them are also widely used. There are also already a couple of Internet databases for the generation of added value at http://www.chargecar.org and furthermore also http://bodytrack.org. Furthermore, a representation and collection of vehicle data by a smartphone application, for example via a Bluetooth or an OBD2 adapter is also conceivable.

The printed document WO 02/30715 A describes a method for triggering at least one restraint means.

### SUMMARY

Against this background, the present disclosure presents a method for detecting at least one unevenness of the road surface, a method for providing an information item about an unevenness of the road surface in the environment of a road user, corresponding devices and a corresponding computer program product according to the features of the disclosure. Advantageous embodiments are obtained from the respective subclaims and the description following.

The present disclosure creates a method for detecting at least one unevenness of the road surface, the method having the following steps:
reading in a plurality of records, each record having at least one geographic position and one information item, allocated to this geographic position, about a locally detected unevenness of the road surface; and
detecting the unevenness of the road surface when information, allocated to an identical geographic position, from a number of records represents in each case a locally detected unevenness of the road surface, the information allocated to the geographic position, in particular, meeting a predefined criterion.

An unevenness of the road surface can be understood to be a deviation in the height of a road surface, particularly an abrupt deepening in the road surface, for example a pothole. A record can be understood to be a bundle of information which has at least one information item relating to a geographic position and a local unevenness of the road surface at this geographic position. A record will thus provide an information item about a (local) unevenness of the road surface detected at the geographic position. This information about the local unevenness of the road surface can be acquired, for example, by a sensor of a vehicle such as, for example, an acceleration sensor or an optical sensor (for example of a vehicle camera) and used for generating the record. A geographic position can be understood to be a geographically unambiguously identifiable position or an area of a predetermined extent around this unambiguously identifiable position. Such an identifiable position or geographic position can be understood to be, for example, a geographic coordinate. The unevenness of the road surface can be detected if from the different records relating to an identical geographic position, one information item each about a (local) unevenness of the road surface detected at this geographic position is contained which, for example, meets a predefined criterion in each case. Such a predefined criterion can be, for example, that the (local) unevenness of the road surface has a predetermined minimum area (for example with respect to a plane of the roadway) and/or a predetermined minimum depth. Alternatively or additionally, the unevenness of the road surface can also be detected as being actually present if only one information item (one that can for example be represented in binary as a flag) is provided about the locally detected unevenness of the road surface with respect to a geographic position.

The present disclosure offers the advantage that by the evaluation of a number of records which are advantageously provided by different vehicles, an unevenness of the road surface at the geographic position can now be detected very precisely. In this context, errors or uncertainties which occur during the detection of individual locally detected unevennesses of the road surface at the geographic position are compensated for by a statistical evaluation. If, for example, a vehicle passes the geographic position very rarely, the detection of a local unevenness of the road surface will be subject to uncertainties at this geographic position whether the measurement result actually provides information about an unevenness of the road surface or is caused by another interfering effect which accidentally occurred at the same geographic position. If, in contrast, for example, a central evaluation of the unevennesses of the road surface detected locally at the geographic position is carried out, it is possible to detect much more precisely what is actually an unevenness of the road surface if with respect to this geographic position, the number of records contain information about a detected local unevenness of the road surface.

One embodiment of the present disclosure is particularly advantageous, in which, in the step of detecting the unevenness of the road surface that is detected when the local unevennesses of the road surface from the different records represent a deepening of the road surface with a predetermined minimum depth and/or a predetermined minimum extent. Such an embodiment of the present disclosure offers the advantage of a particularly rugged and not very fault-prone detection of the unevenness of the road surface actually present.

In order to avoid faults or uncertainties in the detection of the (local) unevennesses of the road surface or largely to compensate for these, it is possible, according to another embodiment of the present disclosure, in the step of reading in, to read in records which are provided by different vehicles. Such an embodiment of the present disclosure offers the advantage that different vehicles detect, for example, the (local) unevennesses of the road surface by different sensors or sensor types so that by means of the type and manner of different detection of the unevennesses of the road surface, a systematic measuring error by an individual (type of) sensor can be largely compensated for or avoided entirely.

An embodiment of the present disclosure is also advantageous, in which, in the step of reading in, the records are read in from a mobile radio interface. Such an embodiment of the present disclosure offers the advantage that the evaluation or detection of the records can take place from a central position at which a multiplicity of records can be collected and evaluated especially by many different vehicles so that the unevenness of the road surface can be detected with a high statistical quality and reliability.

An embodiment of the present disclosure is particularly advantageous, in which, furthermore, a step of outputting the geographic position and the unevenness of the road surface detected in the step of detecting to at least one further vehicle or a road maintenance organization is provided. Such an embodiment of the present disclosure offers the advantage that the detected unevenness of the road surface can be output in a warning message to a further vehicle or a road maintenance organization, for example so that the driver of the further vehicle can drive particularly carefully at the geographic position and thus a member of the road maintenance organization can eliminate the unevenness of the road surface without having to perform cost-intensive measuring trips himself.

Furthermore, a method for providing an information item about an unevenness of the road surface in the environment of a road user is also proposed, the method having the following steps:
detecting a geographic position and an information item about an unevenness of the road surface, allocated to the geographic position, wherein a record is formed from the geographic position and the information item about the unevenness of the road surface allocated to the geographic position; and
transmitting the record from the road user to a central evaluating unit by means of a wireless transmission interface.

A road user can be understood to be, for example, a vehicle (or a driver of a vehicle, respectively), a bicycle (or a bicycle rider) or a pedestrian (or a corresponding device for detecting and transmitting the locally detected unevenness of the road surface). Such an embodiment of the present disclosure offers the advantage that information about the state of the road surface or unevenness of the road surface can be recorded in a decentralized manner and transmitted for central evaluation.

According to a particularly advantageous embodiment of the present disclosure, the step of detecting the information about the unevenness of the road surface can take place at least by using an acceleration sensor and/or an optical sensor. Such an embodiment of the present disclosure offers the advantage that they can often also be used already in modern vehicles as available sensors for additional utilization. This only requires additional software and the costs for the approach proposed here can be kept low.

For example, in order to be able to verify an unevenness of the road surface already detected in a central evaluation unit, the step of detecting, according to an advantageous embodiment of the present disclosure, can also be carried out in response to a detection signal received via the wireless transmission interface wherein, in particular, the detection signal has a position information item which represents the geographic position.

The present disclosure also creates at least one device which is designed for performing or implementing the steps of one of the methods presented here in corresponding devices. By this variant of the embodiment of the disclosure in the form of a device, too, the object forming the basis of the disclosure can be achieved rapidly and efficiently.

In particular, this provides a device for detecting at least one unevenness of the road surface, the device having the following features:
an interface for reading in a plurality of records, each record having at least one geographic position and an information item, allocated to this geographic position, about a locally detected unevenness of the road surface; and
a unit for detecting the unevenness of the road surface when information allocated to an identical geographic position from a number of records in each case represents a local unevenness of the road surface, which especially meets a predefined criterion.

Furthermore, a device for providing an information item about an unevenness of the road surface in the environment of a road user is proposed here, this device having the following features:
a unit for detecting a geographic position and an information item about an unevenness of the road surface allocated to the geographic position, a record being formed from the geographic position and the information item about the unevenness of the road surface allocated to the geographic position; and
an interface for transmitting the record from the road user to a central evaluating unit by means of a wireless transmission interface.

In the present context, a device could be understood to be an electrical device which processes sensor signals and outputs control and/or data signals in dependence thereon. The device can have an interface which can be designed in hardware and/or software. In the case of a hardware design, the interfaces can be, for example, part of a so-called system ASIC which contains the most varied functions of the device. However, it is also possible that the interfaces are separate, integrated circuits and consist at least partially of discrete components. In the case of a software design, the interfaces can be software modules which, for example, are present on a microcontroller, in addition to other software modules.

Of advantage is also a computer program product with program code which can be stored on a machine-readable medium such as a semiconductor memory, a hard-disk memory or an optical memory and is used for performing a method according to one of the embodiments described here when the program product is executed on a computer or a device.

### BRIEF DESCRIPTION OF THE DRAWINGS

In the text which follows, the disclosure will be explained in greater detail by way of example, using the attached drawings, in which:

FIG. 1 shows a block diagram of a system for detecting unevennesses of the road surface by means of devices according to exemplary embodiments of the present disclosure;

FIG. 2 shows a flowchart of a method according to an exemplary embodiment of the present disclosure; and

FIG. 3 shows a flowchart of a further method according to an exemplary embodiment of the present disclosure.

### DETAILED DESCRIPTION

In the subsequent description of preferred exemplary embodiments of the present disclosure, identical or similar reference symbols are used for the elements shown in the various figures and acting in a similar manner, a repeated description of these elements being omitted.

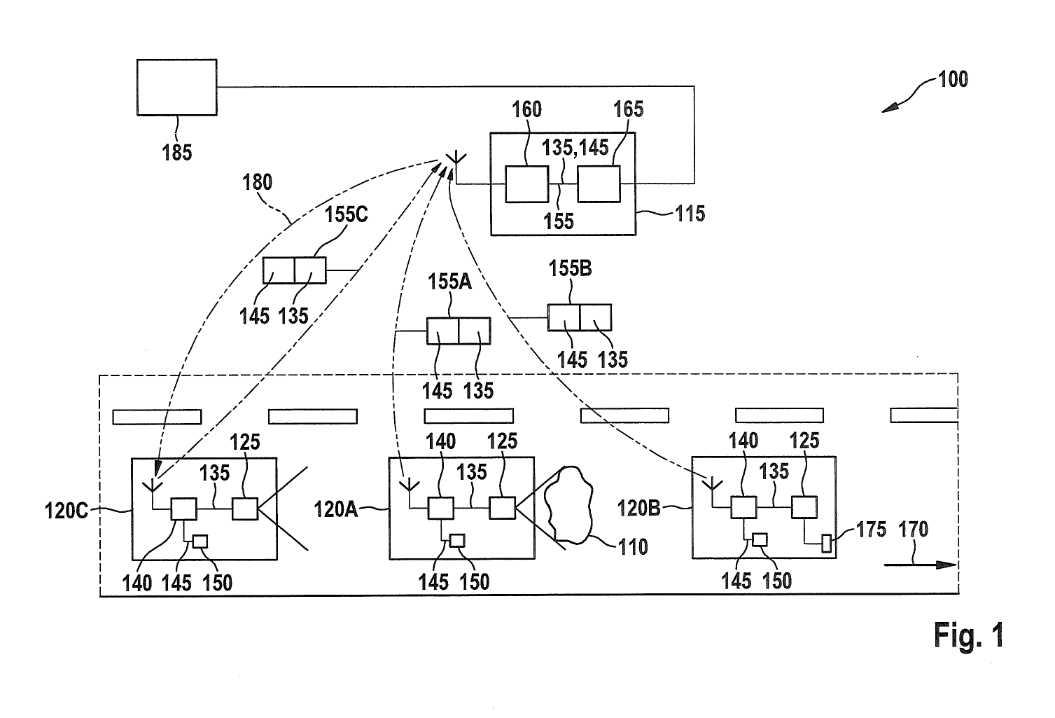

FIG. 1 shows a block diagram of a system 100 for detecting unevennesses of the road surface by means of devices according to exemplary embodiments of the present disclosure. In this system 100, for example, an unevenness 110 of the road surface is detected locally by a road user like a vehicle in this case and identified as actual unevenness of the road surface by a central evaluation unit 115. For this purpose, an area of the road surface 130 in front of the first vehicle 120A is scanned, for example, in a first vehicle 120A by means of a detection unit 125 which is formed, for example, by a vehicle camera having correspondingly designed evaluation electronics, and during this process the unevenness 110 of the road surface is detected locally. An information item 135 about this locally detected unevenness 110 of the road surface is then transmitted to a transmission interface 140. In the transmission interface 140, a geographic position 145 is also read in by a position finding unit 150. This position finding unit 150 can be, for example, a receiver of a satellite positioning system such as, for example, a GPS receiver. This geographic position 145 then represents a geographic coordinate or an area having a predetermined size and/or a predetermined form around the geographic coordinate at which the unevenness 110 of the road surface detected locally by the first vehicle 120A has been detected. In the transmission interface 140, a record 155 is then formed from the information item 135 about the locally detected unevenness 110 of the road surface and the geographic position 145, which record is conveyed, for example, wirelessly to a correspondingly designed receiving interface 180 of the central evaluation unit 115. It is also conceivable that in the record 155, the information item 135 about the locally detected unevenness 110 of the road surface is only implemented as a binary character, that the geographic position 145, contained in the record 155 is to be understood to be the position of a locally known unevenness 110 of the road surface. From the receiving interface 160 of the central evaluation unit 115, the record 155 or the geographic position 145 contained in the record 155, and the information item 135 about the locally detected unevenness 110 of the road surface is then transmitted to an analysis unit 165 of the central evaluation unit 115 in which an analysis described in greater detail in the text which follows will be carried out.

In order to be able to then find as reliable and rugged a detection as possible of the actual presence of the unevenness 110 of the road surface on the road surface 130 and thus to avoid faults or inaccuracy in the identification of the unevenness 110 of the road surface by the devices of the first vehicle 120A, a corresponding record 155B of a second vehicle 120B can be utilized in the central evaluation unit 115 or in the analysis unit 165 respectively, of the central evaluation unit 115. This record 155B of the second vehicle 120B can also again contain, for example, a geographic position 155 and an information item 135 about the presence of the unevenness 110 of the road surface detected locally by the second vehicle 120B. The second vehicle 120B is shown in FIG. 1 at a later time during its travel in the direction of traveling 170, in which it has already passed the unevenness 110 of the road surface on the road surface 130. However, the information item 135 about the presence of the unevenness 110 of the road surface now detected locally by the second vehicle 120B can be recorded already at the time of passing or immediately before passing the locally detected unevenness of the road surface and linked with the geographic position 145, detected at this time, to form the record 155 which can then be transmitted also at a later time to the analysis unit 165 of the central evaluation unit 115 via the receiving interface 160. It is also conceivable that the second vehicle 120B now does not detect the unevenness 110 of the road surface by means of an optical sensor as is done in the first vehicle 120A but that, for example, the signal of an acceleration sensor 175 is evaluated in the detection unit 115 (for example for acceleration jumps having a predetermined pattern) and thus driving over or through the unevenness 110 of the road surface is detected by the second vehicle 120B. Other procedures are also conceivable in order to be able to detect the unevenness 110 of the road surface which, however, are not explained in greater detail in the present description but are known to the relevant expert.

In the analysis unit 165, which can also be called a detection unit for detecting an (actually present) unevenness 110 of the road surface, the records 155A and 155B coming from the different vehicles 120A and 120B or the data contained therein, respectively, can then be evaluated. If, for example, it is detected in the analysis unit 165 that one information item 135 each is present for the same geographic position 145 in the first record 155A and in the second record 155B (or further records, not shown in FIG. 1 of other vehicles also not shown), that an unevenness 110 of the road surface has been detected locally at this geographic position 145 by the vehicles 120A and 120B sending out the relevant records 155A and 155B, respectively, it can be assumed that the unevenness 110 of the road surface detected by the relevant vehicles 120A and 120B (only locally) is also actually present. In this manner, the detection of the unevenness 110 of the road surface by one of the vehicles 120A and 120B, respectively, can be verified and thus a possible faulty detection of the unevenness 110 of the road surface by one of the vehicles 120A and 120B can also be uncovered. It is possible in this manner to detect an unevenness 110 of the road surface on the road surface 130 distinctly more reliably and more ruggedly than if the detection of an unevenness 110 of the road surface is only supported by the detection result of a single vehicle.

It is also conceivable that the unevenness 110 of the road surface actually present is then detected in the analysis unit 165 only when a predetermined number of records, for example more than five or 10 records 155 relating to an identical geographic position 145, each contain an information item 135 that an unevenness 110 of the road surface has been detected locally in a vehicle sending out the relevant record 155 at this geographic position 145.

It is also conceivable that the information item 135 about the unevenness 110 of the road surface, detected locally in the relevant vehicle 120, contains an information item about an area of extent and/or a depth of the unevenness 110 of the road surface below the surface to be traveled over the cover of the road 130, wherein this area of extent and/or depth of the unevenness 110 of the road surface can then be analyzed in the analysis unit 165 and an actually present unevenness 110 of the road surface is only inferred when the area of extent and/or the depth of the unevenness 110 of the road surface is greater than a predetermined reference value. Alternatively or additionally, the information item 135 can be output by the detection unit 125 present in the respective vehicle 120 only when the unevenness 110 of the road surface, detected by the detection unit 125 has an area of extent and/or depth which is greater than a predetermined reference value.

In order to be able to detect as reliably as possible also an unevenness 110 of the road surface, actually present, by means of the analysis unit 165 in the central evaluation unit 115, a detection signal 180 can also be transmitted via a transmission interface 140 of another vehicle 120C. This detection signal 180 can then contain a request to check at the geographic position 145 with respect to the information item 135 already contained in records 155A and 155B, respectively, that at the geographic position 145 the vehicles 120A and 120B sending out the relevant records 155A and 155B have already detected locally an unevenness 110 of the road surface, whether a detection unit 125 of the other vehicle 120C also locally detects an unevenness 110 of the road surface at this geographic position 145. This detection unit 125 can then for example scan an area of the road surface 130 by means of a camera as optical sensor when passing the geographic position 145 contained in the detection signal 180 and to check it for the presence of the unevenness 110 of the road surface. For example, analogously to the procedure in the first vehicle 120A and second vehicle 120B, a corresponding record 155C can then be transmitted back to the analysis unit 162 of the central evaluation unit 115 via the receiving interface 160, which record also contains an information item 135 that an unevenness 110 of the road surface has been detected locally also by the other vehicle 120C at the geographic position contained in the detection signal 180. In this case, it is possible to infer particularly reliably and safely in the analysis unit 165 the actual presence of an unevenness 110 of the road surface on the road surface 130.

It is also conceivable that the central evaluation unit 115 sends or sells a notice relating to the unevenness 110 of the road surface (detected as actually present) including the geographic position 145 allocated to this unevenness 110 of the road surface to a road maintenance organization 185 such as, for example, a road maintenance depot of a freeway so that an employee of this road maintenance organization no longer needs to search the road surface 130 himself for unevennesses 110 of the road surface such as potholes but can drive directly to the geographic position 145 of the unevenness 110 of the road surface detected as actually present, in order to eliminate the unevenness 110 of the road surface.

It is also possible to transmit a warning about the unevenness 110 of the road surface detected as being actually present to drivers of the vehicles which are driving on the road surface 130. This warning or warning information, respectively, can be effected, for example, by means of a signal similar to the detection signal 180 (or in the detection signal 180) to a transmission interface 140 in the relevant vehicles 120 which then outputs the received warning information, for example, acoustically and optically to the driver of the relevant vehicle.

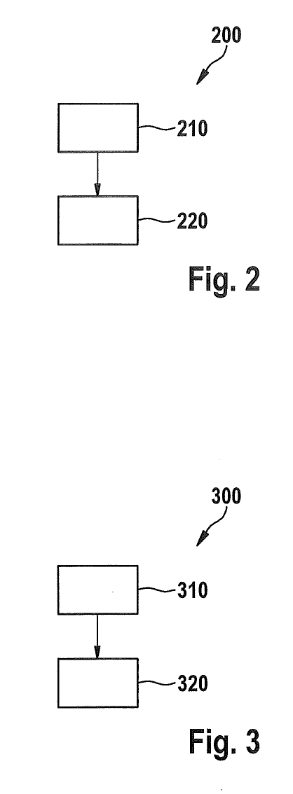

FIG. 2 shows a flowchart of a method 200 for detecting at least one unevenness of the road surface according to an exemplary embodiment of the present disclosure. The method 200 comprises a step 210 of reading in a plurality of records, each record having at least one geographic position and one information item, allocated to this geographic position, about a detected local unevenness of the road surface. Furthermore, the method 200 comprises a step 220 of detecting the unevenness of the road surface when information allocated to an identical geographic position from a number of records in each case represents a local unevenness of the road surface which in particular meets a predefined criterion.

FIG. 3 shows a flowchart of a method 300 for providing an information item about an unevenness of the road surface in the environment of a road user. The method 300 comprises a step 310 of detecting a geographic position and an information item about an unevenness of the road surface allocated to the geographic position, wherein a record is formed from the geographic position and the information item about the unevenness of the road surface allocated to the geographic position. Furthermore, the method 300 comprises a step 320 of transmitting the record from the road user to a central evaluation unit by means of a wireless transmission interface.

A significant aspect of the approach presented here is the reporting and collecting of as many measurement data as possible of participating vehicles in a central database in the Internet and utilizing this database for representing an added value such as the pothole sensor. The results are statistically evaluated in this database and provided again to the participating vehicles. Similarly, it is also possible to utilize data from stationary test points (e.g. air quality measurements in city centers, pollen count reports) in order to process information centrally, for example to verify this processed information and outputting it to other entities. The collection of data in the car can take place particularly appropriately, for example, via a Bluetooth interface between car and smartphone and/or an application on the smartphone. The database could be operated advantageously by the applicant (e.g. Bosch Car Service branding of the database and the linked application), but a non-profit organization created for this purpose by interested parties (supplier, OEMs, government) would also be conceivable. In this context, the balancing of (possibly depersonalized) data reported by vehicles with respect to one another is intended to offer the possibility of arriving at statistically secured “measurement” results which cannot be calculated due to the limited sensor accuracy in the individual vehicle. Similarly, measurement results from vehicle sensors which, per se, do not allow any meaningful additional information to be provided, can provide for such additional information by linkage with data or with other road users (see below, pothole sensor). For this purpose, the data should contain, apart from, for example, temperature, air pressure etc., especially also the location (GPS) of the vehicle.

This permits the statistical balancing with vehicles in the immediate vicinity or on the same road way (at the same time or at other times). This separates the disclosure from the above-mentioned prior art: it is not the car which detects potholes but a statistical evaluation of event messages from vehicles by a central location (database) detects potholes and reports them. By this means, potholes are actually detected with a high degree of reliability and not only events found which could be potholes. In addition, the data are evaluated not in stations along the road but via the Internet in a central service department.

In particular, an embodiment as pothole sensor is proposed in the approach presented here. Data, for example, of the acceleration sensors (or at least “spikes”) are recorded. If spikes occur regularly at the same locations (not only in the case of this vehicle but also in the case of others, already for months, . . . ), this is an indication of a pothole actually present in the road surface. It would be possible to calculate the quality of the road network without effort by the driver and expensive tests during this. The data can be made available to the road construction officers.

To detect the pothole, a camera can be installed, for example, in the headlamp and/or tail light; this is activated when passing a pothole and places a photo relating to the pothole into a database. The activation of the camera must not necessarily be triggered due to a vibration detected by the vehicle itself. Instead, the next vehicle passing could be “requested” (for example by means of a corresponding signal 180) (via Internet database) to take a photo (which would require, in particular, forward-looking cameras). A reversing camera which may already be present can also be used for this purpose, as can video systems of the vehicle which are actually used for traffic monitoring (pedestrian protection, self-braking vehicles etc).

Other embodiments of the approach presented here are also conceivable, some possibilities being quoted in the text which follows which can be based on the technology presented here.
1. Data available in the Internet are edited and incorporated in the database so that they become usable for vehicles. Example and embodiment of such a procedure could be:
   Incorporating the data relating to the current or expected pollen count, available in the Internet or from corresponding information services, in the database.
   Calling up of these data by the vehicle.
   Representing pollen count intensity/type in the vehicle and warning allergic persons, utilizing it for controlling the circulating air in the vehicle, for example for automatically activating the circulating air or a circulating-air mode with a lesser quantity of fresh air. Similar possibilities in the case of fine dust, ozone etc.
2. Similar to 1., it is possible to change to circulating air before entering tunnels, based on GPS.
3. Further location-based control of vehicle functions
   If the vehicle is driving through an inner city (GPS/navigation) and, at the same time, test stations of the city find a particularly high atmospheric loading, vehicles can change their engine management strategy, for example, accept a slightly higher fuel consumption in order to achieve instead, however, a particularly low-NOₓ combustion. Conversely, it would be possible to drive on country roads outside residential areas with consumption-optimized (CO₂-optimized) combustion where increased pollutants such as, for example, NOₓ are not significant.
   Linking what has been mentioned in the previous points with an “echo mode” key. The driver could have the choice whether he wishes to place his car (automatically) in loaded regions into a particularly low-pollutant mode, for example also with reduced power.
   Controlling the cleaning intervals of the particle filter on the basis of the location (GPS) and the current atmospheric loading at this location (Internet database). Cleaning of the filter is then preferably shifted to a less loaded location, e.g. preventing cleaning in a public underground garage.
4. The accuracy of the sensors in the car can be improved by utilizing the data of other cars located in the vicinity. For this purpose, Kaiman filters can be used.
5. Speculatively: there may be a virtual air quality sensor in the control devices of the vehicles. Only the sensors present in any case (for example lambda probe in the exhaust system) are used. Due to the high validation options demanded by the OBD and the over determinate state of the combustion model running in the engine management system, there is a possibility of determining the air quality (fine dust, NOₓ, . . . ). The basic concept of this approach can be seen in the following consideration: if the combustion has to be corrected although there has been no change in the engine, the intake air must have changed. The data of this hypothetical virtual air quality sensor are reported to the database. If systematic deviations from the average of the database for this location and time are found here, this is an indication of a malfunction. This would produce either a further level of OBD validation or, conversely, a sensor could be omitted and an equally good validation could be achieved nevertheless.
6. Drivers can have depersonalized access to the database. Their vehicle could signal statistical data also from other drivers/vehicles to them. For example, the on-board computer could indicate not only the average consumption (current consumption) of its vehicle but also what other vehicles (possibly of similar class) have consumed at this location. Positive feedback for economical drivers. Positive feedback for sporting drivers could be average speed for a section.
   Generally, the range display could be improved not only for EVs (electric vehicles) but also for combustion-type vehicles. The vehicle receives average consumptions for the selected distance with a wide statistical database (all cars which have traveled there at any time or, for example, especially at the same time, with the same traffic volume). The vehicle has already learnt in the past that its driver is rather above (below) the downloaded consumptions and adapts the residual range correspondingly.
7. Cameras present in the vehicle can be triggered automatically in the case of a crash detection. The data are then provided to the rescuers in the Internet database, possibly also live images “web cam”. In association therewith, pre-crash data can also be signaled to the database (possibly in a particularly great detailed depth) (black box in the Internet).
8. Intervention of ESPs can be reported in the database. As a result, hazardous road sections can be determined automatically. Apart from hazardous curves, it can also indicate deer crossings. Conversely, such data can also be called up by the car itself before the road lying ahead of the car in order to then warn the driver. Apart from principally hazardous routes, current events such as deer crossings, loose gravel or black ice can also be exchanged. Then similar to the preceding item, a reporting of loose gravel or e.g. slippery places caused by oil (detected by ESP) can save the life of following motor cyclists.
9. In general, the communication between vehicles can be a replacement for Car2Car communication (for example about road condition, accident). Communication via a third party (Internet database) is clearly less complex and does not need any new technology (in contrast to Car2Car).
10. Pedestrians, too, can be linked into the Internet database communication and, for example, warned against black ice or even against approaching cars. In particular, subscribers with vehicle already have everything necessary with them (smartphone with App) after disembarking. As a transmission path, the following scenario would be conceivable here, for example:
   As a transmission path, a mobile application could also be used. This could receive the data via a Bluetooth interface. Something similar is already available with Bluetooth OBD adapter available on the market. Via the application, the driver could give his consent to the use of the data or select what information is transmitted (anonymously). Users (particularly the younger ones) are already used to such interrogation via the legal enquiry by iPhone/Android applications. Via the mobile application, the driver/passenger could also, in particular, add information via a touch button or mark locations for later input of information (after the end of the trip). For example pothole message. In the Internet, there are already many examples of communities formed around such applications.
   The following procedure for the transmission of data is also conceivable:
   The community around the application is formed by the added value provided to it. For example, members can compare their data with others.
   The costs for the applicant arise from application programming, database operation and marketing.
   The added value for the applicant arises from:
      Advertisement for Bosch Car Service (branding of the App).
      In the case of OBD error messages and/or in the case of statistical accumulation of certain sensor messages (ESP interventions can indicate poor shock absorbers, long braking paths similarly or also worn brakes), advertisements can be inserted with the site and navigation to the nearest Bosch Car Service.
      Statistically produced data such as road condition, potholes could be sold as a packet to road maintenance depots and other institutions (which would normally have to conduct test trips themselves).
   The business model suits the strategy of the applicant to offer services increased in future.

In particular, a type of “pothole sensor with Internet database” is thus presented by the approach presented here. In this context, an electronic unit/system is used, for example of acceleration sensors, controller and data transmission unit which can deliver data for a central database. As well, an embodiment of an acceleration sensor can be used which delivers corresponding raw data. Furthermore, an embodiment of the approach presented here as controller is conceivable which can preprocess raw data. Furthermore, an embodiment of the approach presented here as controller for linking GPS and acceleration sensor data is conceivable or an embodiment as HMI (human-machine interface) for displaying reported and received data to the driver and permitting, for example, driver interactions. In addition, an embodiment of the approach presented here as controller for linking, for example, GPS data, acceleration sensor data and reversing camera data is conceivable.

The approach presented here thus essentially relates to a concept for the fusion of sensor data of vehicles and other sources (e.g. DWD, pollen count prediction etc.) in a centralized database in the Internet and especially to obtaining additional information (virtual sensors) and action recommendations by means of statistical evaluation and comparison of data of one's own vehicle, especially sensor data, with the data of other road users or also stationary test points.

The exemplary embodiments described and shown in the figures are selected only as examples. Different exemplary embodiments can be combined with one another completely or with respect to individual features. As well, an exemplary embodiment can be supplemented by features of another exemplary embodiment.

Furthermore, method steps according to the disclosure can be executed repeatedly and in another order than that described here.

If an exemplary embodiment comprises an “and/or” link between a first feature and a second feature, it is to be read in such a manner that the exemplary embodiment according to one embodiment has both the first feature and the second feature and, according to another embodiment, has either only the first feature or only the second feature.

What is claimed is:

1. A method for detecting at least one unevenness of a road surface, comprising:
reading in a plurality of records, each record having at least one geographic position and one information item allocated to this geographic position about a detected local unevenness of the road surface; and
detecting the unevenness of the road surface when information allocated to an identical geographic position from a number of records represents in each case a locally detected unevenness of the road surface.

2. The method according to claim 1, wherein the unevenness of the road surface is detected when the local unevennesses of the road surface from the different records represent a deepening of the road surface with one or more of a predetermined minimum depth and a predetermined minimum area.

3. The method according to claim 1, wherein the plurality of records includes records provided by one or more of different vehicles and road users.

4. The method according to claim 1, wherein the plurality of records includes records from a mobile radio interface.

5. The method according to claim 1, further comprising outputting the geographic position and the detected unevenness of the road surface to one or more of at least one further vehicle and a road maintenance organization.

6. A method for providing an information item about an unevenness of the road surface in the environment of a road user, comprising:
detecting a geographic position and an information item about an unevenness of the road surface allocated to the geographic position;
forming a record from the geographic position and the information item about the unevenness of the road surface allocated to the geographic position; and
transmitting the record from the road user to a central evaluating unit by a wireless transmission interface.

7. The method according to claim 6, wherein the information about the unevenness of the road surface is obtained at least by using one or more of an acceleration sensor and an optical sensor.

8. The method according to claim 6, wherein the detecting the geographic position and the information item is carried out in response to a detection signal received via the wireless transmission interface.

9. A device having units configured to perform or drive the method according to claim 1.

10. A computer program product having program code configured to perform the method according claim 1.

11. The method according to claim 8, wherein the detection signal has a position information item which represents the geographic position.
